(19) United States
(12) Patent Application Publication
(10) Pub. No.: US 2006/0162984 A1
(43) Pub. Date: Jul. 27, 2006

(54) Crash sensor for sensing an impact to a vehicle in response to reduced light intensity and an associated method

(75) Inventors: Michael C. McCarthy, Birmingham, MI (US); Carl A. Munch, Troy, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive U.S. LLC

(21) Appl. No.: 11/042,637

(22) Filed: Jan. 25, 2005

(51) Int. Cl. B60K 28/10

(52) U.S. Cl. 180/274

(57) ABSTRACT

A sensor (14) for sensing an impact to a vehicle (10) comprises a deformable member (26) through which an elongated chamber (30) extends. Deformation of the deformable member (26) is indicative of an impact to the vehicle (10). A light source (74) emits light through the chamber (30). A first detector (104) senses an intensity of the light emitted by the light source (74) and provides a first intensity signal indicative thereof. A second detector (96) senses the intensity of the light that passes through the chamber (30) and provides a second intensity signal indicative thereof. The intensity of the light that passes through the chamber (30) varies as a function of deformation of the deformable member (26). A controller (62) analyzes the first and second intensity signals to determine whether an impact to the vehicle (10) has occurred.

### TECHNICAL FIELD

The present invention relates to a sensor for sensing an impact to a vehicle, and to an associated method. More particularly, the present invention relates to an infrared crash sensor that is responsive to an intensity of the infrared light for determining whether an impact to a vehicle has occurred, and to an associated method.

### BACKGROUND OF THE INVENTION

Actuatable vehicle occupant protection systems are well known in the art. Such protection systems include one or more vehicle crash sensors for detecting the occurrence of a vehicle crash condition. When a vehicle crash condition is detected, the protection system may actuate an inflatable device, such as an air bag, for helping to protect an occupant of the vehicle.

Known vehicle crash sensors include mechanical devices, such as switches, that close in response to deformation of the vehicle. The closure of the mechanical device indicates the occurrence of a vehicle crash condition. Other known vehicle crash sensors are electrical devices, such as an accelerometer. When a processed output of the electrical device crosses a threshold level, a vehicle crash condition is determined.

Vehicle crash sensors for detecting a side impact to a vehicle must have particularly rapid response times as the time period for actuating an inflatable device for occupant protection during a side impact is significantly less than the time period for actuating an inflatable device for occupant protection during a front impact. To help improve the response time of a vehicle crash sensor for sensing side impacts, it is common to locate the vehicle crash sensor at the side of the vehicle, such as on a side pillar or within the door of the vehicle.

Some difficulties arise when the vehicle crash sensor is located within the door of the vehicle. For example, the vehicle crash sensor must be able to sense a side impact, but must be immune to actions such as door slams. Also, a vehicle crash sensor within the door must be immune to low force impacts to the door such as those common when a door is opened into an object.

### SUMMARY OF THE INVENTION

The present invention relates to a sensor for sensing an impact to a vehicle. The sensor comprises a deformable member through which an elongated chamber extends. Deformation of the deformable member is indicative of an impact to the vehicle. The sensor also includes a light source for emitting light through the chamber and first and second detectors. The first detector senses an intensity of the light emitted by the light source and provides a first intensity signal indicative thereof. The second detector senses the intensity of the light that passes through the chamber and provides a second intensity signal indicative thereof. The intensity of the light that passes through the chamber varies as a function of deformation of the deformable member. The sensor also comprises a controller for analyzing the first and second intensity signals to determine whether an impact to the vehicle has occurred.

In accordance with another aspect, the present invention relates to a sensor for sensing an impact to a vehicle. The sensor comprises a deformable member through which an elongated chamber extends. The chamber defines a free optical path between first and second ends of the deformable member. Deformation of the deformable member is indicative of an impact to the vehicle. The sensor also comprises a reflective member that is located at the first end of the deformable member. A sensor module is located at the second end of the deformable member. The sensor module includes a light source and a detector. The light source emits light through the chamber along the free optical path toward the reflective member. The detector senses an intensity of light that is reflected by the reflective member and that returns through the chamber along the free optical path to the sensor module. The intensity of the light returning to the sensor module varies as a function of deformation of the deformable member. A controller of the sensor module is responsive to the sensed intensity of light for determining whether a vehicle impact has occurred.

In accordance with yet another aspect, the present invention relates to a method for sensing an impact to a vehicle. The method comprises the step of emitting light through a chamber of a deformable member. Deformation of the deformable member is indicative of an impact to the vehicle. The method also comprises the steps of sensing an intensity of the emitted light and providing a first intensity signal indicative thereof; and sensing an intensity of the light that passes through the chamber of the deformable member and providing a second intensity signal indicative thereof. The intensity of the light that passes through the chamber varies as a function of deformation of the deformable member. The method further comprises the step of analyzing the first and second intensity signals to determine whether an impact to the vehicle has occurred.

In accordance with still another aspect, the present invention relates to a method for sensing an impact to a vehicle. The method comprises the step of emitting light along a free optical path through a chamber of a deformable member. Deformation of the deformable member is indicative of an impact to the vehicle. The method also comprises the steps of reflecting the light back through the chamber along the free optical path; sensing an intensity of the light that returns through the chamber along the free optical path; and determining deformation of the deformable member from the sensed intensity of the light. The sensed intensity of the light varies as a function of the deformation of the deformable member. The method further includes the step of determining, in response to the determined deformation of the deformable member, whether an impact to the vehicle has occurred.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 illustrates a vehicle that includes a sensor constructed in accordance with an exemplary embodiment of the present invention;

FIG. 2 is a view, partially in section, of the sensor of FIG. 1 in a non-deformed condition;

FIG. 3 is a view, partially in section, of the sensor of FIG. 1 in a deformed condition;

FIG. 4 is a schematic illustration of a sensor module of the sensor of FIG. 1;

FIGS. 5A-5F are graphical illustrations of various signals of the sensor of FIG. 1; and

FIG. 6 is a flow diagram of an exemplary process performed by a sensor of the present invention.

### DETAILED DESCRIPTION OF THE INVENTION

FIG. 1 is a side view of a vehicle 10. The vehicle 10 of FIG. 1 includes a door 12 within which a sensor 14 constructed in accordance with the present invention is located. When located within the door 12, the sensor 14 senses side impacts to the vehicle 10. Although the sensor 14 is located within the door 12 in the exemplary embodiment of FIG. 1, the sensor 14 may be located at other locations of the vehicle 12. For example, the sensor 14 may be located within a side panel 16 of the vehicle 10 adjacent the door 12 for sensing a side impact to the vehicle. Alternatively, the sensor 14 may be located at the front of the vehicle 10 for sensing a front impact to the vehicle.

FIG. 1 also illustrates an electronic control unit 20 that is operatively connected to the sensor 14. The electronic control unit 20 may be a microcomputer or any other known controller for controlling actuation of one or more actuatable occupant protection devices. FIG. 1 illustrates a side curtain 22 as an exemplary actuatable occupant protection device. As an alternative to the side curtain 22, the actuatable occupant protection device may include one or more of an inflatable air bag, an inflatable seat belt, an inflatable knee bolster, an inflatable head liner, a knee bolster operated by an inflatable air bag, or any other type of actuatable occupant protection device. When the electronic control unit 20 receives a signal from the sensor 14 indicating the occurrence of a vehicle crash condition, the electronic control unit 20 actuates the actuatable occupant protection device, e.g., the side curtain 22, for helping to protect an occupant (not shown) of the vehicle 10.

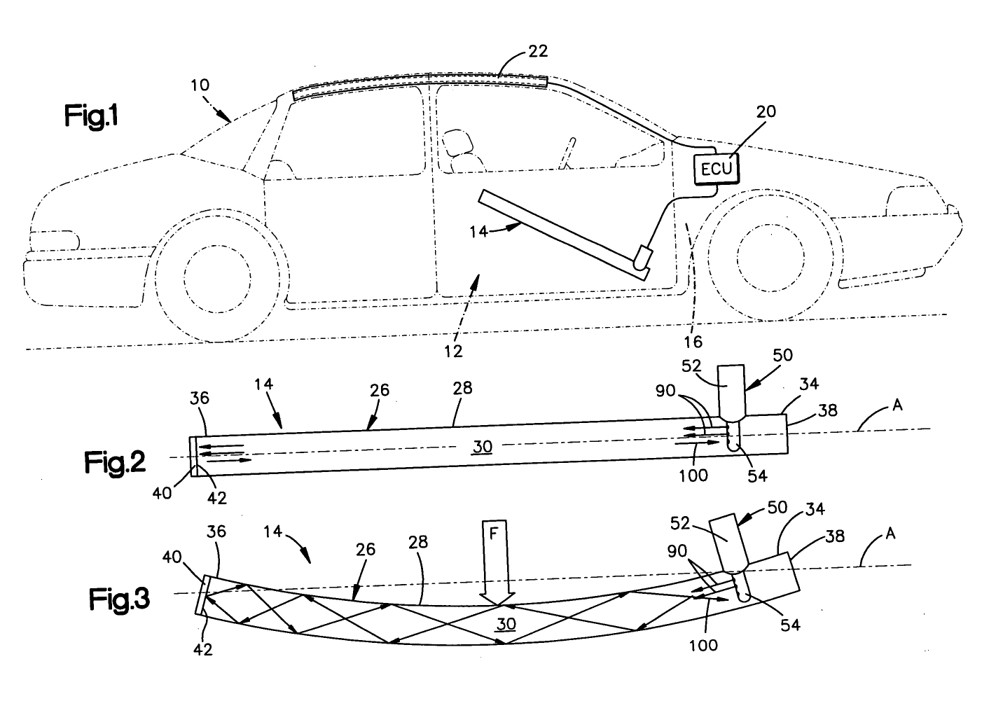

FIG. 2 is a view, partially in section, of the sensor 14. In the embodiment illustrated in FIG. 2, the sensor 14 includes a tubular member 26. FIG. 2 illustrates the tubular member 26 as having a circular cross-sectional shape. The tubular member 26, however, may have any cross-sectional shape. The tubular member 26 of FIG. 2 includes an annular wall 28 that defines an axially elongated chamber 30. Axis A of FIG. 2 defines a center of the chamber 30. The tubular member 26 may be formed from structure of the vehicle 10 or may be separate from the structure of the vehicle. In the exemplary embodiment illustrated in FIG. 1, the tubular member 26 is a steel reinforcement member of the door 12 of the vehicle 10.

The tubular member 26 also includes opposite first and second ends 34 and 36, respectively. An endcap 38 closes the first end 34 of the tubular member 26. A reflective member 40 closes the second end 36 of the tubular member 26. The reflective member 40 includes a polished metal surface 42 that defines an end of the chamber 30. The polished metal surface 42 of the reflective member 40 extends generally perpendicular to the centerline, illustrated as axis A in FIG. 2, of the chamber 30. As an alternative to the reflective member 40 having the polished metal surface 42, the reflective member 40 may include other structure for reflecting light, such as a mirrored surface.

The sensor 14 also includes a sensor module 50. The sensor module 50 includes a protective housing 52. As shown in FIG. 2, the sensor module 50 is mounted to the tubular member 26 adjacent the first end 34. When the sensor module 50 is mounted to the tubular member 26, a portion 54 of the sensor module 50 is located within the chamber 30. In an exemplary embodiment of the invention, the sensor module 50 is located approximately three feet away from the polished metal surface 42 of the reflective member 40.

The chamber 30 of the sensor 14 is sealed so as to prevent dirt, debris, moisture, or other contaminants from entering the chamber. With the exception of the portion 54 of the sensor module 50, the chamber 30 is free of any other structures. As a result, a free optical path is defined in the chamber 30 between the portion 54 of the sensor module 50 and the polished metal surface 42 of the reflective member 40.

The sensor module 50 is configured to emit light through the chamber 30 along the free optical path from the sensor module toward the polished metal surface 42 of the reflective member 40. The sensor module 50 is also configured to detect the intensity of the light that has been reflected by the polished metal surface 42 of the reflective member 40 and that has passed back through the chamber 30 along the free optical path to the sensor module 50.

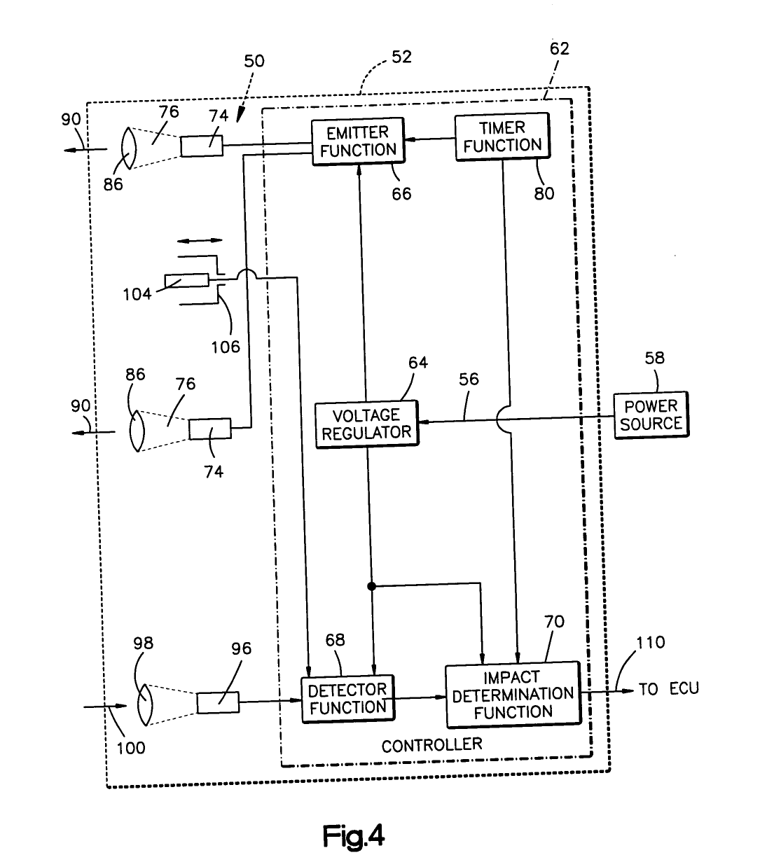

FIG. 4 schematically illustrates the sensor module 50. An input 56 into the protective housing 52 of the sensor module 50 provides electrical energy from a power source 58, such as the battery of the vehicle 10. The electrical energy is directed to a controller 62 of the sensor module 50. The controller 62 may be a microcomputer, an application specific integrated circuit (ASIC), or may be formed from discrete circuitry.

The controller 62 includes a voltage regulator 64. The electrical energy that is input into the controller 62 from the power source 58 is supplied to the voltage regulator 64. The voltage regulator 64 supplies regulated electrical energy to other portions of the controller 62.

As shown schematically in FIG. 4, the controller 62 also includes an emitter function 66, a detector function 68, and an impact determination function 70. Each of the emitter function 66, the detector function 68, and the impact determination function 70 may be performed by software of the controller 62.

The emitter function 66 controls emitters 74 of the sensor module 50. The embodiment of the sensor module 50 illustrated in FIGS. 2-4 includes two emitters 74. The emitters 74 are light emitting diodes (“LEDs”) that are configured for emitting infrared light. In an exemplary embodiment, the emitters 74 are high performance infrared emitters sold by Agilent Technologies as part number HSDL-4420. As shown schematically in FIG. 4, the emitters 74 are wired in series with one another. Although the exemplary embodiment illustrates two emitters 74, the present invention may use only a single emitter or may use more than two emitters. The number of emitters 74 is chosen to provide a predetermined intensity of light.

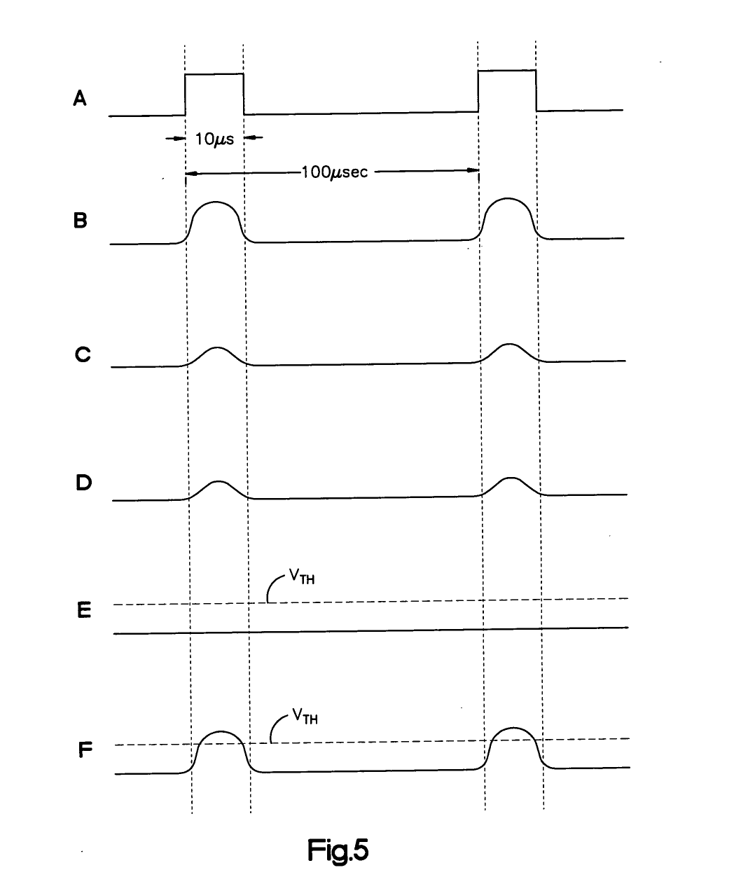

The emitter function 66 of the controller 62 provides electrical energy to the emitters 74 for energizing the emitters to provide light. FIG. 4 schematically illustrates the light provided by the emitters 74 at 76. In an exemplary embodiment of the invention, the emitter function 66 receives timing signals from a timer function 80 of the controller 62. The emitter function 66 is responsive to the timing signals for controlling the emitters 74 for providing a pulsed output. For example, the emitter function 66 may control the emitters 74 for providing a light pulse having a ten microsecond duration at intervals of 100 microseconds. FIG. 5A schematically illustrates the pulsed output of the emitters 74. By controlling the emitters 74 for providing light pulses, the emitter function 66 reduces the current draw required by the sensor module 50 as compared to when the emitters 74 are continuously providing light.

As illustrated in FIG. 4, each emitter 74 has an associated lens 86. Each lens 86 is chosen so that a focal point of the lens lies on the polished metal surface 42 of the reflective member 40. The light 76 that is provided by each emitter 74 is directed toward its associated lens 86. The associated lens 86 focuses the light 76 onto the polished metal surface 42 of the reflective member 40. FIG. 4 schematically illustrates the light focused by each lens 86 as an arrow labeled 90.

The sensor module 50 also includes a detector 96. The detector 96 is a photodiode that is configured for sensing an intensity of light and for providing a detector signal indicative of the sensed intensity. In an exemplary embodiment, the detector 96 is a high performance infrared photodiode sold by Agilent Technologies as part number HSDL-5420. A lens 98 is associated with the detector 96. As is shown schematically in FIG. 4, the lens 98 focuses light onto the detector 96.

The detector 96 is operable for sensing the intensity of light that is reflected off of the polished metal surface 42 of the reflective member 40 and that has returned to the sensor module 50. FIG. 4 schematically illustrates the reflected light at 100. The detector 96 outputs the detector signal, which is indicative of the sensed intensity of the light 100, to the detector function 68 of the controller 62. FIG. 5B schematically illustrates an exemplary detector signal for the sensor 14 of FIG. 2 in response to the pulse output of FIG. 5A.

The sensor module 50 also includes a reference detector 104. The reference detector 104 is also a photodiode that is configured for sensing an intensity of light. The reference detector 104 provides a reference signal indicative of the sensed intensity to the detector function 68 of the controller 62. In an exemplary embodiment, the reference detector 104 is a high performance infrared photodiode sold by Agilent Technologies as part number HSDL-5420.

The reference detector 104 is located in the protective housing 52 of the sensor module 50. An adjustable shield 106 is associated with the reference detector 104. The reference detector 104 is partially exposed to the light 76 provided by the emitters 74. A position of the adjustable shield 106 controls the amount of exposure of the reference detector 104 to the light 76 provided by the emitters 74. The reference detector 104 outputs the reference signal, which is indicative of the sensed intensity of the light 76. FIG. 5C schematically illustrates an exemplary reference signal for the sensor 14 of FIG. 2 in response to the pulsed output of FIG. 5A.

The reference signal provided by the reference detector 106 enables the control module 50 to compensate for variations in the light intensity that may result from variations in electrical power. For example, when the current supplied to the emitters 74 is lower than normal, the intensity of the light 76 provided by the emitters 74 is also lower than normal. As a result, the intensity of the reflected light 100 detected by the detector 96 is lower than is normally expected. The reference signal from the reference detector 104 is used to prevent an improper determination of an impact to the vehicle 10 as a result of the changes or fluctuations in the electrical energy supplied to the emitters 74.

The detector function 68 of the controller 62 receives the detector signal output from the detector 96 and the reference signal output from the reference detector 104. In an exemplary embodiment of the invention, the detector function 68 subtracts the reference signal from the detector signal and provides a difference signal to the impact determination function 70 of the controller 62. By subtracting the reference signal provided by the reference detector 104 from the detector signal, variations in electrical energy will no longer result in improper impact determinations.

The impact determination function 70 of the controller 62 is operable for analyzing the difference signal to determine whether an impact to the vehicle 10 has occurred. In an exemplary embodiment of the invention, the impact determination function 70 compares the difference signal to a predetermined threshold for determining whether an impact to the vehicle 10 has occurred. When the impact determination function 70 determines that an impact has occurred, the impact determination function 70 provides a sensor signal 110 to the electronic control unit 20. The electronic control unit 20 is responsive to the sensor signal 110 for controlling actuation of the side curtain 22.

Alternatively, the impact determination function 70 may include a memory (not shown) in which a look-up table is stored. The look-up table may, for example, correlate the difference signal to the severity of an impact. The impact determination function 70 may be responsive to the received difference signal for providing a sensor signal 110 to the electronic control unit 20 that is indicative of the severity of the impact. The electronic control unit 20 is responsive to the sensor signal 110 for controlling actuation of the side curtain 22.

When the tubular member 26 of the sensor 14 is in a non-deformed condition, as shown in FIG. 2, the light 90 emitted from the sensor module 50 passes through the chamber 30 along the free optical path from the sensor module 50 to the polished metal surface 42 of the reflective member 40. The light 90 reflects off of the reflective member 40 and the reflected light 100 passes back through the chamber 30 along the free optical path toward the sensor module 50. The detector 96 of the sensor module 50 senses the intensity of the reflected light 100 that has returned to the sensor module 50 and provides the detector signal to the detector function 68 of the controller 62.

Upon the occurrence of an impact to the side of the vehicle 10, for example, into the door 12, a force F (FIG. 3) is applied to the tubular member 26. The tubular member 26 is designed to deform when subjected to a force exceeding a predetermined amount. FIG. 3 illustrates the force F acting upon a central portion of the tubular member 26. The force F of FIG. 3 is greater than the predetermined amount and has deformed the tubular member 26. As shown in FIG. 3, the tubular member 26 has been deformed so that the central portion of the tubular member is spaced away from axis A and no direct line of sight exists between the sensor module 50 and the reflective member 40.

When the tubular member 26 is deformed as illustrated in FIG. 3, the light 90 provided by the emitters 74 of the sensor module 50 is not directed onto the polished metal surface 42 of the reflective member 40, but is, instead, directed into the annular wall 28 of the tubular member 26. The light 90 that is directed into the annular wall 28 is scattered in various directions by the surface of the annular wall 28. Some of the light reflects from the annular wall 28 and continues through the tubular member 26 toward the reflective member 40. As a result of the light 90 being reflected off of the annular wall 28 of the tubular member 26, the intensity of the reflected light 100 sensed by the detector 96 of the sensor module 50 is low, as compared to when a direct line of sight exists between the sensor module 50 and the reflective member 40, as is shown in FIG. 2.

Generally, the greater the degree of deformation of the tubular member 26, the lower the intensity of the reflected light 100 sensed by the detector 96. FIG. 5D illustrates a detector signal for the sensor module 50 of FIG. 3 in response to the pulsed input of FIG. 5A.

In an exemplary embodiment of the invention, the adjustable shield 106 associated with the reference detector 104 is positioned so that the reference signal provided by the reference detector is equal to the detector signal when no direct line of sight exists between the sensor module 50 and the reflective member 40. Thus, the reference signal shown in FIG. 5C is identical to the detector signal shown in FIG. 5D. As a result, when the detector function 68 subtracts the reference signal of FIG. 5C from the detector signal of FIG. 5D for the deformed tubular member 26 illustrated in FIG. 3, the determined difference signal that is provided to the impact determination function 70 has a value of zero, as is shown in FIG. 5E. On the other hand, when the detector function 68 subtracts the reference signal from the detector signal for the non-deformed tubular member 26 illustrated in FIG. 2, the determined difference signal that is provided to the impact determination function 70 has a value as illustrated in FIG. 5F.

FIGS. 5E and 5F also illustrate an exemplary predetermined threshold V_{TH} of the impact determination function 70. As can be seen with reference to FIG. 5E, the difference signal is lower than the predetermined threshold V_{TH}. As a result, impact determination function 70 determines that an impact to the vehicle 10 has occurred. As can be seen with reference to FIG. 5F, the difference signal, at predetermined intervals determined from timing signals from the timer function 80, is greater than the predetermined threshold V_{TH}. As a result, impact determination function 70 determines that no impact to the vehicle 10 has occurred. The impact determination function 70 outputs a sensor signal 110 to the electronic control unit 20 indicative of the determined impact condition. The electronic control unit 20, in response to receiving a sensor signal 110, controls actuation of the side curtain 22.

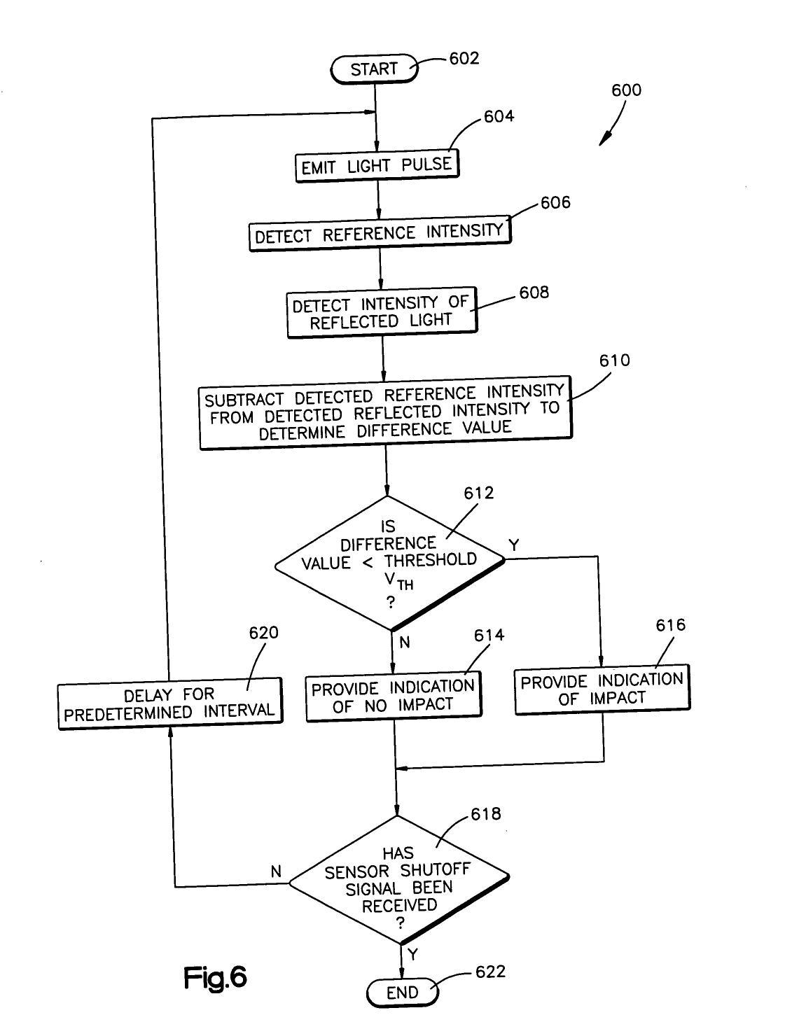

FIG. 6 is a flow diagram of an exemplary process 600 performed by a sensor 14 of the present invention. The process 600 begins at step 602 in response to the sensor 14 being activated. The sensor 14 may be activated, for example, when the ignition (not shown) of the vehicle 10 is turned on. At step 604, light 90 is emitted by the emitters 74 of the sensor module 50.

The process 600 proceeds from step 604 to step 606. At step 606, a reference intensity of the emitted light 90 is detected. The reference detector 104 detects the reference intensity of the emitted light 90. At step 608, the intensity of the reflected light 100 is detected. The detector 96 detects the intensity of the reflected light 100.

From step 608, the process 600 proceeds to step 610. At step 610, a difference value is determined by subtracting the detected reference intensity of step 606 from the detected reflected light intensity of step 608. At step 612, a determination is made as to whether the determined difference value is less than a predetermined threshold V_{TH}. When the determination at step 612 is negative and the determined difference value is not less than the predetermined threshold V_{TH}, the process 600 proceeds to step 614 in which the sensor 14 outputs an indication that no impact has occurred. When the determination at step 612 is affirmative and the determined difference value is less than the predetermined threshold V_{TH}, the process 600 proceeds to step 616 in which the sensor 14 outputs an indication that an impact to the vehicle 10 has occurred.

From steps 614 and 616, the process 600 proceeds to step 618. At step 618, a determination is made as to whether a sensor shutoff signal has been received. A sensor shutoff signal may be received, for example, when the ignition of the vehicle 10 is turned off. When the determination at step 618 is negative, the process 600 proceeds to step 620. At step 620, a delay of a predetermined interval occurs. The process 600 returns to step 604 from step 620. When the determination at step 618 is affirmative, the process 600 proceeds to step 622 and the process ends.

From the above description of the invention, those skilled in the art will perceive improvements, changes and modifications. Such improvements, changes and modifications within the skill of the art are intended to be covered by the appended claims.

Having described the invention, we claim the following:

1. A sensor for sensing an impact to a vehicle, the sensor comprising:
a deformable member through which an elongated chamber extends, deformation of the deformable member being indicative of an impact to the vehicle;
a light source emitting light through the chamber;
a first detector for sensing an intensity of the light emitted by the light source and for providing a first intensity signal indicative thereof;
a second detector for sensing the intensity of the light that passes through the chamber and for providing a second intensity signal indicative thereof, the intensity of the light that passes through the chamber varying as a function of deformation of the deformable member; and
a controller for analyzing the first and second intensity signals to determine whether an impact to the vehicle has occurred.

2. The sensor of claim 1 wherein the sensor is located in a door of the vehicle and is adapted to sense a side impact to the vehicle.

3. The sensor of claim 2 wherein the deformable member forms a reinforcement member of the door.

4. The sensor of claim 1 wherein the controller includes a detector function that determines a difference value by subtracting the first intensity signal from the second intensity signal, the controller also including an impact determination function for comparing the determined difference value to a threshold value for determining whether an impact to the vehicle has occurred.

5. The sensor of claim 4 wherein a shield is associated with the first detector, a position of the shield relative to the first detector being adjustable for controlling a value of the first intensity signal.

6. The sensor of claim 1 wherein the controller includes means for emitting light in pulses.

7. The sensor of claim 1 wherein the light source, the first and second detectors, and the controller collectively form a sensor module, the sensor module being located at a first end of the deformable member, a reflective member being located at a second end of the deformable member for reflecting the light emitted from the light source back through the chamber toward the sensor module.

8. The sensor of claim 7 wherein the chamber defines a free optical path between the first and second ends of the deformable member, the light emitted from the light source passing through the chamber along the free optical path toward the reflective member, the light that is reflected by the reflective member passing through the chamber along the free optical path toward the sensor module.

9. The sensor of claim 7 wherein reflective member includes a polished metal surface, the polished metal surface reflecting light.

10. The sensor of claim 7 wherein the sensor module also includes at least one lens that is associated with the light source, the lens being configured to focus the light emitted by the light source on the reflective member.

11. A sensor for sensing an impact to a vehicle, the sensor comprising:
a deformable member through which an elongated chamber extends, the chamber defining a free optical path between first and second ends of the deformable member, deformation of the deformable member being indicative of an impact to the vehicle;
a reflective member located at the first end of the deformable member; and
a sensor module located at the second end of the deformable member, the sensor module including a light source and a detector, the light source emitting light through the chamber along the free optical path toward the reflective member, the detector sensing an intensity of light that is reflected by the reflective member and that returns through the chamber along the free optical path to the sensor module, the intensity of the light returning to the sensor module varying as a function of deformation of the deformable member, a controller of the sensor module being responsive to the sensed intensity of light for determining whether a vehicle impact has occurred.

12. The sensor of claim 11 wherein the sensor is located in a door of the vehicle and is adapted to sense a side impact to the vehicle.

13. The sensor of claim 12 wherein the deformable member forms a reinforcement member of the door.

14. The sensor of claim 11 wherein the detector forms a first detector of the sensor module and the sensor module also includes a second detector for sensing an intensity of the light emitted by the light source, the controller analyzing a first intensity signal from the first detector and a second intensity signal from the second detector for determining whether an impact to the vehicle has occurred.

15. The sensor of claim 14 wherein the controller includes a detector function that determines a difference value by subtracting the second intensity signal from the first intensity signal, the controller also including an impact determination function for comparing the determined difference value to a threshold value for determining whether an impact to the vehicle has occurred.

16. The sensor of claim 14 wherein a shield is associated with the second detector, a position of the shield relative to the second detector being adjustable for controlling a value of the second intensity signal.

17. The sensor of claim 11 wherein the reflective member includes a polished metal surface, the polished metal surface reflecting light.

18. The sensor of claim 11 wherein the sensor module also includes at least one lens that is associated with the light source, the lens being configured to focus the light emitted by the light source on the reflective member.

19. A method for sensing an impact to a vehicle, the method comprising the steps of:
emitting light through a chamber of a deformable member, deformation of the deformable member being indicative of an impact to the vehicle;
sensing an intensity of the emitted light and providing a first intensity signal indicative thereof;
sensing an intensity of the light that passes through the chamber of the deformable member and providing a second intensity signal indicative thereof, the intensity of the light that passes through the chamber varying as a function of deformation of the deformable member;
analyzing the first and second intensity signals to determine whether an impact to the vehicle has occurred.

20. The method of claim 19 wherein the step of analyzing the first and second intensity signals includes the steps of:
subtracting the first intensity signal from the second intensity signal to determine a difference value; and
comparing the determined difference value to a threshold value to determine whether an impact to the vehicle has occurred.

21. The method of claim 19 wherein the step of sensing an intensity of the light that passes through the chamber of the deformable member includes the step of:
sensing an intensity of the light that passes through the chamber along a free optical path, reflects off of a reflective member, and passes back through the chamber along the free optical path.

22. A method for sensing an impact to a vehicle, the method comprising the steps of:
emitting light along a free optical path through a chamber of a deformable member, deformation of the deformable member being indicative of an impact to the vehicle;
reflecting the light back through the chamber along the free optical path;
sensing an intensity of the light that returns through the chamber along the free optical path;
determining deformation of the deformable member from the sensed intensity of the light, the sensed intensity of the light varying as a function of the deformation of the deformable member; and
determining, in response to the determined deformation of the deformable member, whether an impact to the vehicle has occurred.

23. The method of claim 22 further including the steps of:
sensing an intensity of the emitted light and providing a first intensity signal indicative thereof;
providing a second intensity signal indicative of the sensed intensity of the light that returns through the chamber along the free optical path; and
analyzing the first and second intensity signals to determine whether an impact to the vehicle has occurred.

24. The method of claim 23 wherein the step of analyzing the first and second intensity signals includes the steps of:
subtracting the first intensity signal from the second intensity signal to determine a difference value; and
comparing the determined difference value to a threshold value to determine whether an impact to the vehicle has occurred.
